(19) United States
(12) Patent Application Publication
(10) Pub. No.: US 2013/0020103 A1
(43) Pub. Date: Jan. 24, 2013

(54) MULTI-HEAD POWER TOOL WITH REVERSE LOCK-OUT CAPABILITY

(71) Applicants: STEVEN MCCLASKEY, NORTH LAS VEGAS, NV (US); JOHN S. VANTRAN, PARKTON, MD (US)

(72) Inventors: STEVEN MCCLASKEY, NORTH LAS VEGAS, NV (US); JOHN S. VANTRAN, PARKTON, MD (US)

(73) Assignee: BLACK & DECKER, INC., Newark, DE (US)

(21) Appl. No.: 13/541,404

(22) Filed: Jul. 3, 2012

Related U.S. Application Data
(60) Provisional application No. 61/508,962, filed on Jul. 18, 2011.

(51) Int. Cl. B25F 3/00; G05G 5/04; B25F 5/00

(52) U.S. Cl. 173/29; 173/170; 74/527

(57) ABSTRACT

A handheld power tool having a detachable tool head is disclosed in which, depending on the type of tool head used, selection of reverse movement of the rotary assembly of the power tool can be prevented. Where reverse movement of the tool head is undesirable, such as for a saw blade, the tool head contains a contact plate that slides a plate member to a position to prevent selection of the reverse direction by the user. However, where reverse movement of a tool head is desired, such as for a drill head, the plate member remains in its original position such that forward and reverse directions can be selected by a user.

### CROSS-REFERENCE TO RELATED APPLICATIONS

This application, having attorney docket number TBDC.163297, claims the benefit of and priority to commonly owned U.S. Provisional Application Ser. No. 61/508,962, also having attorney docket number TBDC.163297, filed Jul. 18, 2011, which is hereby incorporated by reference in its entirety.

### STATEMENT REGARDING FEDERALLY SPONSORED RESEARCH OR DEVELOPMENT

Not applicable.

### TECHNICAL FIELD

The present invention relates generally to a handheld power tool having interchangeable tool heads where the direction of rotary movement of the tool head is controllable.

### BACKGROUND

Since their inception, power tools have provided craftsman with improved performance and ease of use. In more recent years, advancements in portable power technology have lead to incorporating the improved performance provided by a power tool into a handheld and often times, cordless configuration. These handheld power tools have provided increased flexibility and freedom of use by operators as well as increased efficiency by craftsman. A handheld power tool generally includes a handle mechanism, a trigger switch, a tool head, and a motor capable of moving the tool head in a desired direction.

To further increase ease of use and flexibility, some handheld power tools have advanced so as to permit interchangeability of the tool head. By permitting interchangeability, the same handle mechanism and motor can be used to operate different types of tool heads, such as a drill or driver, a circular saw, a sander, or a jigsaw. While this interchangeability provides convenience to the user, it also introduces the risk of permitting undesireable movement of the tool head, which can lead to serious injury of the tool operator, damage to the power tool, or damage to the surface on which the tool is operating. That is, certain tools heads such as a sander, jigsaw or circular saw are preferably not operated in a reverse direction.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Embodiments of the present invention are directed to a handheld power tool and a component thereof which restricts selection of reverse movement of the rotary assembly depending on the type of detachable tool head fixed to the power tool. In one aspect, an embodiment of the present invention is directed to a handheld power tool comprising a handle, a tool housing, a rotary assembly having a shaft, a plate member with an opening for regulating movement of the shaft, a detachable tool head capable of contacting the plate member, and a retainer pin positioned within the opening and coupled to a direction-selection switch. Depending on the type of tool head installed on the tool housing and rotary assembly, the plate member may slide axially so as to limit movement of the retainer pin, thereby preventing movement of the direction-selection switch to a position where the shaft of the rotary assembly moves in a reverse direction.

In another aspect of the present invention, a plate member for controlling a rotating member of a handheld power tool is disclosed, where the plate member is formed from sheet metal and has an opening located therein, with the opening having a series of edges, where at one end of the opening a retainer pin can move between two positions (forward and neutral) and at an opposing end of the opening, the retainer pin can move between three positions (forward, neutral, and reverse).

In yet another aspect, an embodiment of the present invention is directed to a direction-controlling assembly of a handheld power tool comprising a plate member with an opening having a series of edges to define a region in which a retainer pin is permitted to move, where the retainer pin is coupled to a direction-selection switch. The position of the plate member relative to the retainer pin depends on the type of tool head attached to the handheld power tool. Therefore, depending on the type of tool head attached to the power tool, the plate member can slide and restrict movement of the retainer pin and, in turn, the direction-selection switch.

### BRIEF DESCRIPTION OF THE SEVERAL VIEWS OF THE DRAWINGS

In the accompanying drawings, which form a part of the specification and are to be read in conjunction therewith and in which like reference numerals are employed to indicate like parts in the various views:

FIG. 1 is a perspective view of handheld power tool assembly and tool head in accordance with an embodiment of the present invention;

FIG. 2 is a partial cross section view of a portion of the handheld power tool assembly of FIG. 1 in accordance with an embodiment of the present invention;

FIG. 3 is a fragmentary, cross section view of a portion of the handheld power tool assembly and tool head of FIG. 1 in which the tool head is shown in a detached position in accordance with an embodiment of the present invention;

FIG. 4 is a fragmentary, cross section view of a portion of the handheld power tool assembly and tool head of FIG. 1 in which the tool head is shown in the process of being attached to the tool housing and rotary assembly in accordance with an embodiment of the present invention;

FIG. 5 is a fragmentary, cross section view of a portion of the handheld power tool assembly and tool head of FIG. 1 in which the tool head is shown attached to the tool housing and rotary assembly in accordance with an embodiment of the present invention;

FIG. 6 is a top plan view of a plate member of a handheld power tool assembly in accordance with an embodiment of the present invention;

FIG. 7A is a top plan view of a direction-controlling assembly for use in a handheld power tool assembly in an orientation where rotational movement is not restricted in accordance with an embodiment of the present invention;

FIG. 7B is a top plan view of a direction-controlling assembly for use in a handheld power tool assembly in an orientation where rotational movement is restricted in accordance with an embodiment of the present invention; and,

FIGS. 8A, 8B, and 8C depict top plan views of a direction-controlling assembly for use in a handheld power tool assembly depicting different positions for the plate member in accordance with an embodiment of the present invention.

### DETAILED DESCRIPTION

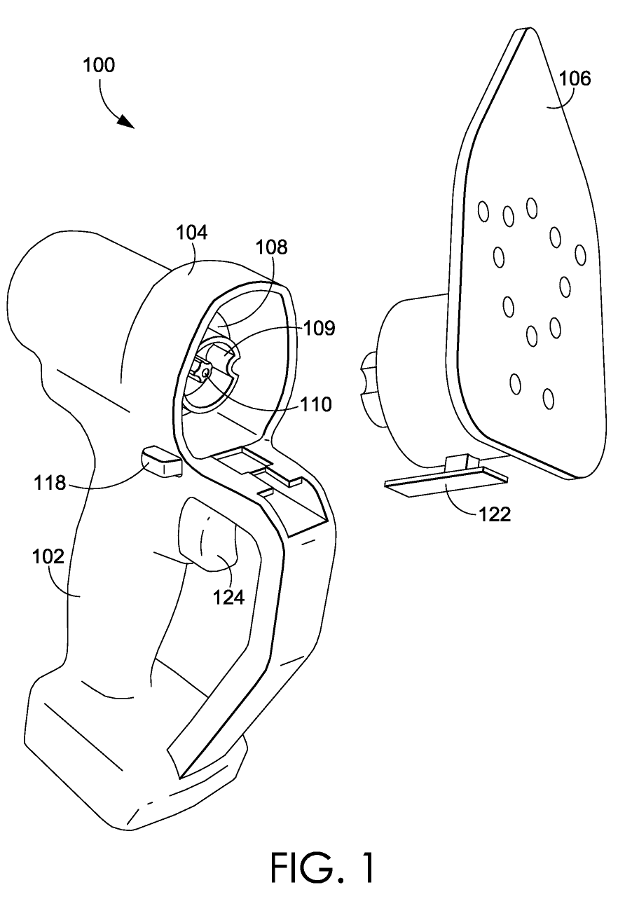

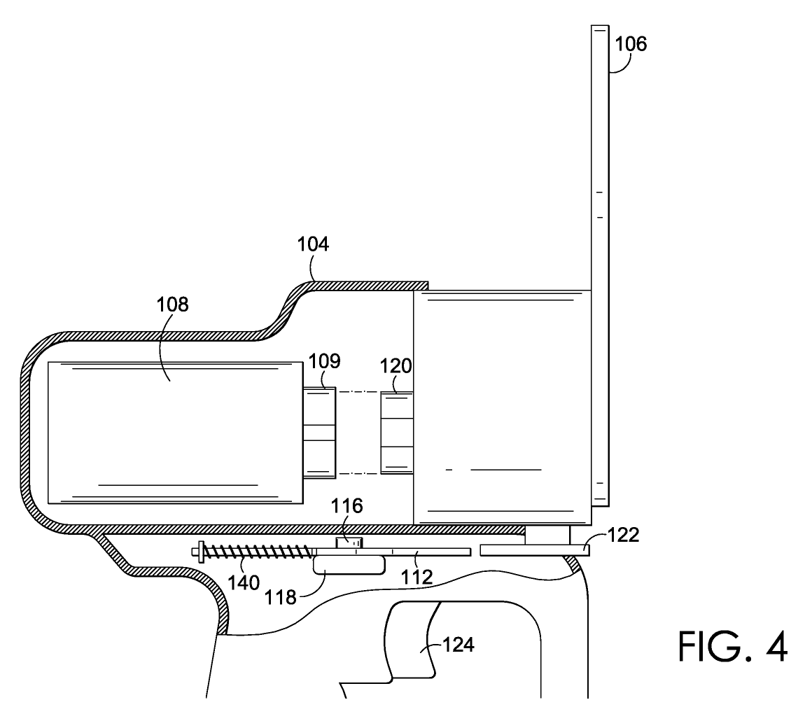

With reference to the drawings, wherein like reference characters designate like parts throughout the different views, a handheld power tool 100 is depicted in FIGS. 1-5. Specifically, the handheld power tool 100 comprises a handle 102, coupled to a tool housing 104, where the tool housing 104 is sized to receive a detachable tool head 106 and encloses a rotary assembly 108. The rotary assembly 108 includes a motor (not shown) which drives a rotatable shaft 110 in both a forward and reverse direction. The rotary assembly also includes an alignment flange 109 which cooperates with the tool head to assure proper orientation of the tool head 106 when coupled with the tool housing 104. The handle 102 and tool housing 104 may be constructed as one integral part through a casted metal casing or plastic molded construction or alternatively through a mechanical coupling of individual components.

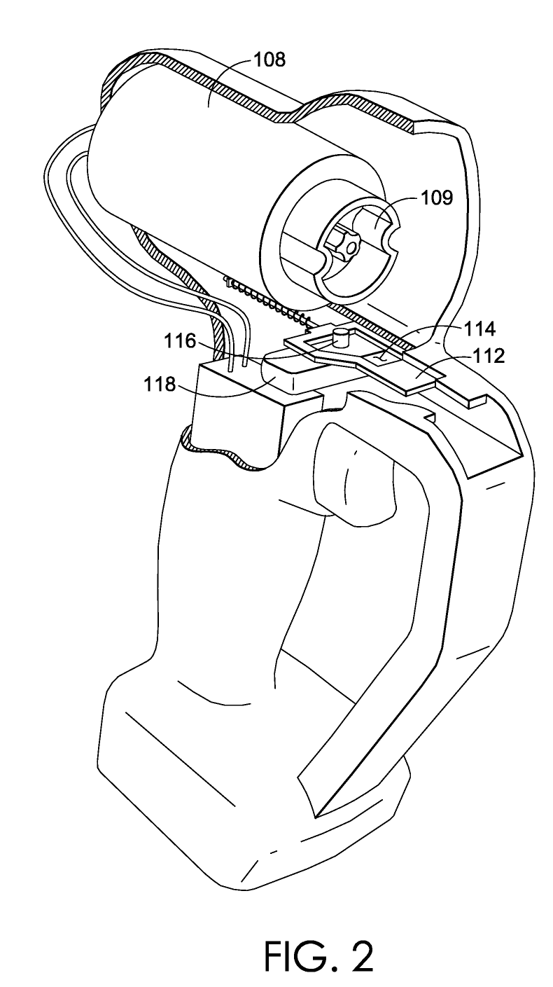

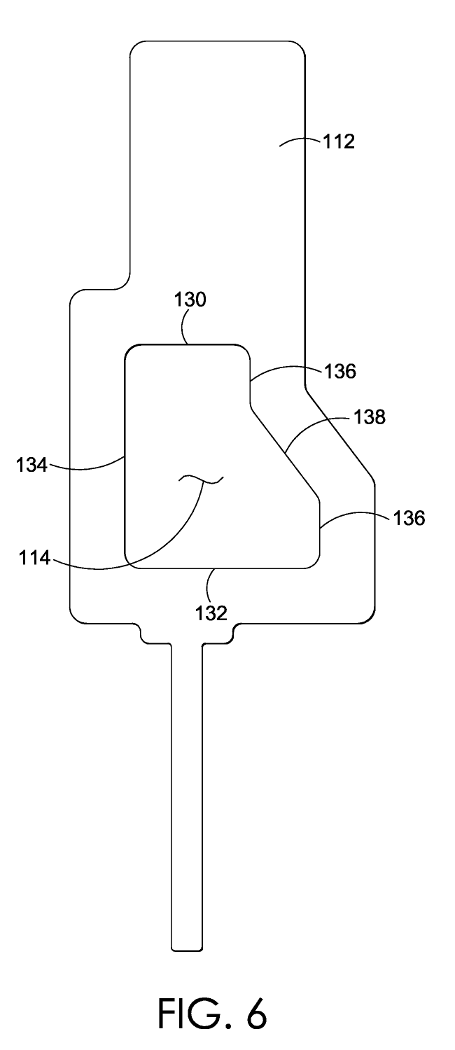

Referring to FIG. 2, the handheld power tool 100 also comprises a plate member 112. Further details of the plate member are shown in FIG. 6 and discussed below. The plate member 112 includes an opening 114 which is sized to limit the movement of a retainer pin 116, which is positioned within the opening 114, and is associated with a direction-selection switch 118. By selectively limiting movement of the direction-selection switch 118, the plate member 112 is able to control the rotational direction of the shaft 110. Depending upon the preferred construction, the retainer pin 116 is coupled to the direction-selection switch 118 or formed integral with the direction-selection switch 118.

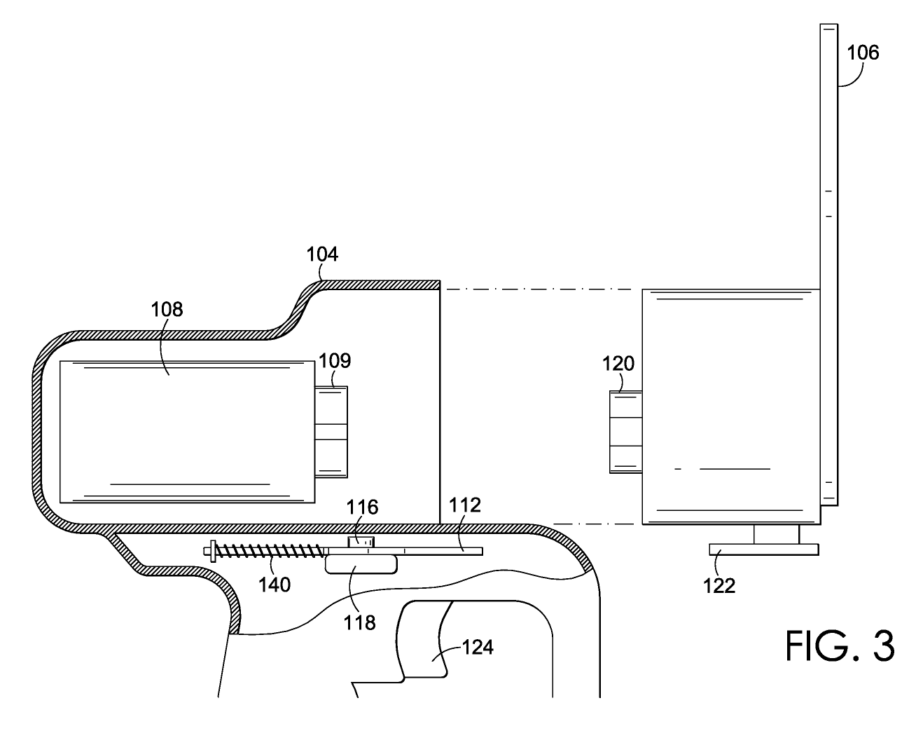

As previously discussed, the handheld power tool 100 also includes a detachable tool head 106. However, it is desirable to be able to change the tool head 106 to a different type of tool head depending on the operation to be performed. The detachable tool head 106 is coupled to the rotary assembly 108 and the tool housing 104. This attachment and detachment process is shown in more detail in FIGS. 3-5. The detachable tool head 106 includes a mounting portion 120 which couples with the alignment flange of the rotary assembly 108, as shown in FIGS. 1 and 3-5.

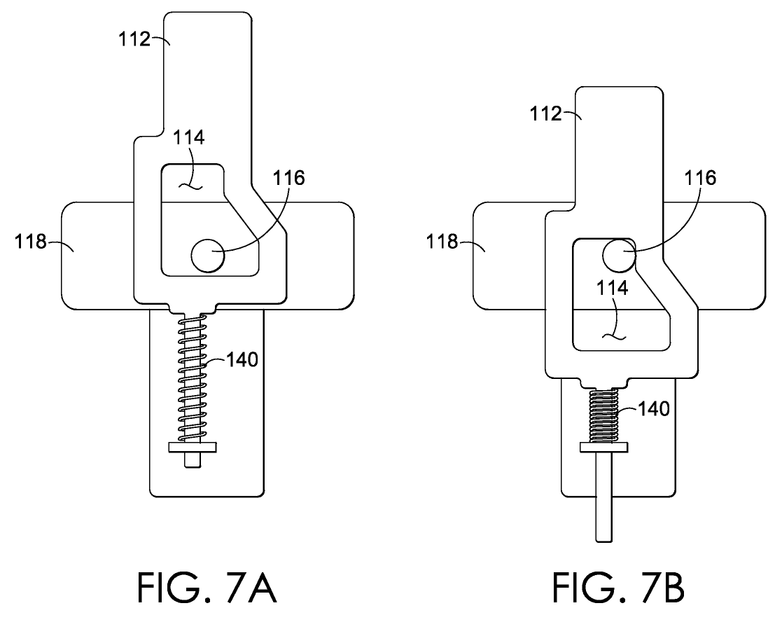

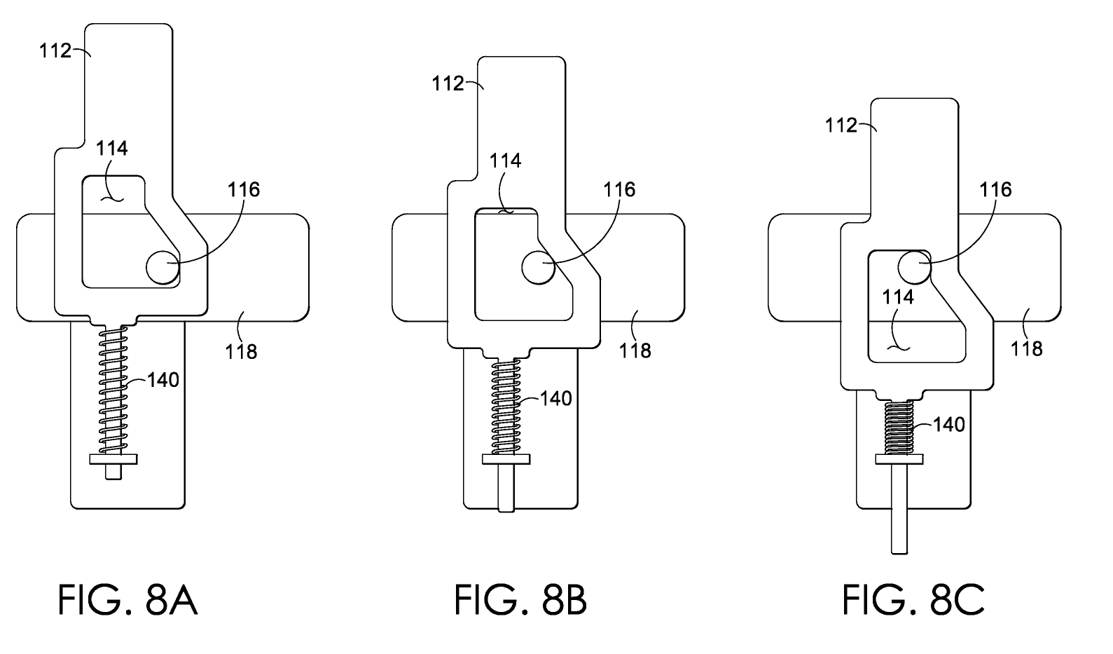

In an embodiment of the present invention, the detachable tool head 106 also includes a projection with a contact plate 122 that is capable of contacting the plate member 112. Depending on the detachable tool head 106 that is selected and coupled with the tool housing 104, the contact plate 122 may contact the plate member 112 such that the plate member 112 translates axially. The translating or sliding movement of the plate member 112 causes the opening 114 to also translate axially and thereby restrict movement of the retainer pin 116. FIGS. 7A and 7B depict the axial translation of the plate member 112 relative to the retainer pin 116. Because the retainer pin 116 is coupled to the direction-selection switch 118, by restricting movement of the retainer pin 116, selection of the direction of rotation is thereby limited.

The size (i.e. length) of the contact plate 122 will determine whether the plate member 112 will move, thereby restricting movement of the retainer pin 116 and selection of a rotational direction of movement for the tool head 106. Therefore, preventing rotational capability of the tool head is controlled by the size of the contact plate 122. That is, for tool heads such as drills, where rotational movement in both forward and reverse is desired, the contact plate 122 is sized to not contact the plate member 112 or the contact plate 122 can be omitted altogether.

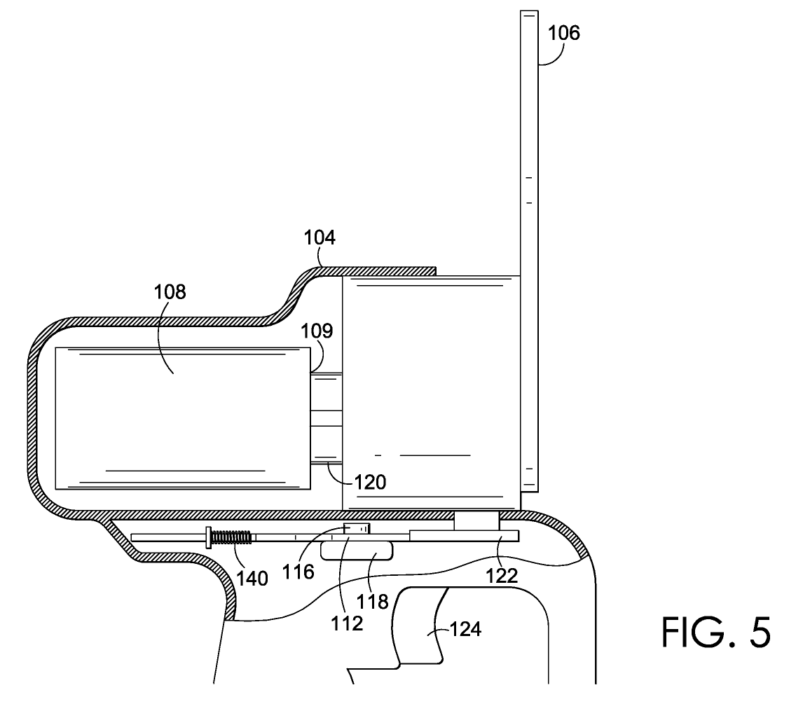

On the other hand, when a tool head 106 such as a sander, jigsaw, or circular saw is coupled with the tool housing 104, it is preferred that these tools not operate in a reverse direction. Rotational movement of the shaft in one direction only is desired for use with saw head components because the rotation of the axis in a forward direction causes the saw blade to move in a direction favorable to cutting. Movement in an opposite direction inhibits cutting, and an operator may be inclined to apply more force to try and force the saw to cut, potentially breaking the saw blades or causing other potential injuries. Therefore, in order to prevent rotation in a reverse direction, the contact plate 122 is sized such that when the detachable tool head 106 is coupled with the tool housing 104 and rotary assembly 108 (as shown in FIG. 5), the contact plate 122 contacts the plate member 112, causing the plate member 112 to translate axially or slide from a position depicted in FIG. 7A to a position depicted in FIG. 7B. In this configuration, the plate member 112 moves due to contact with the contact plate 122 and the retainer pin 116 is only able to toggle between a forward direction position and a neutral, non-rotational position. Furthermore, when the detachable tool head 106 is not attached to the rotary assembly 108, the retainer pin 116 is in a neutral position, but is permitted to select either a forward and/or reverse direction. An example of this configuration is shown in FIG. 2.

The handheld power tool 100 also comprises a trigger switch 124 located in the handle 102. Through the trigger switch 124, an operator is able to activate and control the motor of the rotary assembly 108 by regulating the power supplied to the motor from a power source (not shown).

In an embodiment of the present invention, a plate member 112 for controlling a direction of a rotating member of a power tool is disclosed. The plate member 112 is depicted in FIG. 6 and comprises a planar member having a thickness and an opening 114 having a first edge 130 and a second edge 132 opposite and generally parallel to the first edge 130. The opening 114 also comprises a third edge 134 that is generally perpendicular to the first edge 130 and a plurality of fourth edges 136 generally parallel to the third edge 134. The opening 114 also comprises a fifth edge 138 that extends between the fourth edges 136 and is oriented at an angle relative to the fourth edges 136. The orientation of the fifth edge at an angle provides a camming surface or way for the plate member 112 to move given the retainer pin 116. The plate member 112 may be formed out of sheet metal.

As shown in FIG. 6, the first edge 130 has a first length that is shorter than a second length of the second edge 132. Referring to FIGS. 7A and 7B, depending on the position of the plate member 112, the retainer pin 116 can move between two positions along the first edge 130 and between three positions along the second edge 132. When the retainer pin 116 is adjacent the first edge 130 (as in FIG. 7B), the power tool 100 is capable of operating in forward and neutral positions. Furthermore, when the retainer pin 116 is adjacent the second edge 132 (as in FIG. 7A), the power tool 100 is capable of operating in a forward, neutral, and reverse conditions.

Located adjacent an end of the plate member 112 is a spring 140 for biasing the plate member 112 in its nominal position, as shown in FIG. 7A. Referring to FIGS. 3, 5, 7A, and 7B, the spring 140 is used to bias the plate member 112 in a position permitting three-way movement of the direction-selection switch 118. However, when the plate member 112 has moved axially rearward with respect to the tool head and downward in the drawings due to a force applied by the contact plate 122, the spring 140 is compressed, and the position of plate member 112 prevents selection of a reverse direction by the direction-selection switch 118, as shown in FIG. 7B, where the retainer pin 116 is located adjacent to the first edge 130 of opening 114. However, when a non-reverse tool head 106 is removed, the plate member 112 is returned to its previous position, shown in FIG. 7A, due to the bias of spring 140.

In an embodiment of the present invention, a direction-controlling assembly 130 is disclosed. The direction-controlling assembly 130, which is depicted in FIGS. 7A and 7B, comprises the plate member 112 and an opening 114 extending therethrough and located within the plate member 112. The opening 114 is in accordance with the opening previously described above. The direction-controlling assembly 130 also comprises a direction-selection switch 118 having a retainer pin 116 extending therefrom, with the retainer pin 116 positioned within the opening 114 of the plate member 112. Movement of the direction-selection switch 118 may be restricted depending on the type of detachable tool head attached to the power tool 100 and the location of the opening 114 of the plate member 112 relative to the retainer pin 116.

The present invention has been described in relation to particular embodiments, which are intended in all respects to be illustrative rather than restrictive. Alternative embodiments will become apparent to those of ordinary skill in the art to which the present invention pertains without departing from its scope. Substitutions may be made and equivalents employed herein without departing from the scope of the invention as recited in the claims. It will be understood that certain features and subcombinations are of utility and may be employed without reference to other features and subcombinations. This is contemplated and within the scope of the claims.

The invention claimed is:

1. A handheld power tool comprising:
a handle;
a tool housing;
a rotary assembly located within the tool housing and capable of rotating a shaft in a forward and reverse direction;
a plate member having an opening located therein;
a detachable tool head couplable to the rotary assembly and the tool housing, the tool head having a contact plate capable of contacting the plate member; and
a retainer pin positioned within the opening of the plate member, the retainer pin coupled to a direction-selection switch;
wherein upon axial movement of the plate member by the contacting plate the opening in the plate member limits movement of the retainer pin and selection of an operating direction by the direction-selection switch.

2. The handheld power tool of claim 1, wherein movement of the plate member depends on the type of tool head coupled to the tool housing and rotary assembly.

3. The handheld power tool of claim 1, wherein the handle further comprises a trigger switch for activating the rotary assembly.

4. The handheld power tool of claim 1, wherein when a sanding head, a jigsaw head or a circular saw head are coupled to the power tool, the plate member slides in an axial direction such that the retainer pin is located adjacent to a first end of the plate member.

5. The handheld power tool of claim 4, wherein the shaft is prevented from a reverse motion when the sanding head, jigsaw head or circular saw head is coupled to the power tool.

6. The handheld power tool of claim 1, wherein the pin is moved to a neutral position from a reverse position when a tool head having a contact plate is coupled with the rotary assembly.

7. The handheld power tool of claim 1, wherein the rotary assembly is permitted to operate in a reverse motion when a drill head is attached.

8. The handheld power tool of claim 1, wherein the plate member permits forward and reverse motion of the rotary assembly when no tool head is attached to the rotary assembly.

9. A plate member for controlling a direction of a rotating member of a power tool comprising:
a planar member having a thickness; and
an opening extending through the thickness and located within the planar member, the opening having:
a first edge;
a second edge opposite and generally parallel to the first edge;
a third edge generally perpendicular to the first edge;
a plurality of fourth edges generally parallel to the third edge; and
a fifth edge extending between the fourth edges and oriented at an angle relative to the fourth edges;
wherein the first edge has a first length shorter than a second length of the second edge, wherein the plate member can slide axially between multiple positions, and wherein a retainer pin can move between two positions along the first edge and between three positions along the second edge.

10. The plate member of claim 9, wherein when the pin is adjacent the first edge, the power tool is capable of operating in forward and neutral conditions.

11. The plate member of claim 9, wherein when the pin is adjacent the second edge, the power tool is capable of operating in a forward, neutral, and reverse condition.

12. The plate member of claim 9, wherein the plate member contacts a spring at an end of the plate member.

13. The plate member of claim 12, wherein when the plate member compresses the spring, the retainer pin is located adjacent the first edge of the plate member.

14. The plate member of claim 12, wherein when the spring is in an uncompressed state, the retainer pin is located adjacent the second edge of the plate member.

15. The plate member of claim 9, wherein an axial position of the member depends on a tool head coupled to the power tool.

16. A direction-controlling assembly of a handheld power tool comprising:
a plate member having a thickness and an opening extending through the thickness and located within the plate member, the opening having:
a first edge;
a second edge opposite and generally parallel to the first edge;
a third edge generally perpendicular to the first edge;
a plurality of fourth edges generally parallel to the third edge; and
a fifth edge extending between the fourth edges and oriented at an angle relative to the fourth edges; and
a direction-selection switch tab having a retainer pin extending therefrom and positioned within the opening;
wherein selection of a rotation direction by the direction-selection switch is controlled based on a detachable tool head configuration and a location of the opening of the plate member relative to the retainer pin.

17. The direction-controlling assembly of claim 16, wherein when a drill tool head is connected to the power tool, the plate member is in a position that permits movement of the direction-selection switch to select forward, neutral, and reverse directions.

18. The direction-controlling assembly of claim 17, wherein the retainer pin is adjacent the second edge of the plate member when movement in the forward, neutral or reverse directions is selected.

19. The direction-controlling assembly of claim 16, wherein when a sanding head, jigsaw head or circular saw head is coupled to the power tool, the plate member is in a position that prevents the direction-selection switch from selecting a reverse direction.

20. The direction-controlling assembly of claim 19, wherein the retainer pin is adjacent the first edge of the plate member when movement in the forward or neutral directions is selected.
